(19) United States
(12) Patent Application Publication
(10) Pub. No.: US 2003/0034297 A1
(43) Pub. Date: Feb. 20, 2003

(54) Solids settler

(76) Inventor: Dinh-Cuong Vuong, Sugar Land, TX (US)

Correspondence Address: STEPHEN H. CAGLE, HOWREY, SIMON, ARNOLD & WHITE, LLP, 750 BERING DRIVE, HOUSTON, TX, 77057, US

(21) Appl. No.: 09/930,323

(22) Filed: Aug. 15, 2001

(51) Int. Cl. B01D 17/00

(52) U.S. Cl. 210/533

(57) ABSTRACT

The present invention involves a new design for a solids settler for use in solids removal from a liquid. The new solids settler design includes a liquid inlet means that injects the feed to the solids settler into an inner coagulation chamber of the solids settler. The liquid inlet means directs the flow of the feed so that the feed flows in a circular pattern within the coagulation chamber. The coagulation chamber also has a partially closed bottom portion that causes the feed to reflex, providing for additional mixing within the coagulation chamber

### BACKGROUND OF THE INVENTION

High pressure, high temperature gasification systems have been used to partially oxidize hydrocarbonaceous fuels to recover useful by-products or energy. The fuels can be admixed with water to form an aqueous feedstock that is fed to the reaction zone of a partial oxidation gasifier along with a oxygen containing gas and a temperature moderator.

Mixing the feed with water may not be necessary, given the composition and physical nature of the feedstock. Generally, solid carbonaceous fuels will need to be liquefied with oil or water prior to feeding to the gasifier. Liquid and gaseous hydrocarbonaceous fuels may be suitable for direct feed to the gasifier, but can be pre-treated for removal of any impurities that might be present in the feed.

The term liquid hydrocarbonaceous fuel as used herein to describe various suitable feedstocks is intended to include pumpable liquid hydrocarbon materials and pumpable liquid slurries of solid carbonaceous materials, and mixtures thereof. In fact, any combustible carbon-containing liquid organic material, or slurries thereof may be included within the definition of the term “liquid hydrocarbonaceous.” For example, there are pumpable slurries of solid carbonaceous fuels, liquid hydrocarbon fuel feedstocks, oxygenated hydrocarbonaceous organic materials, and mixtures thereof. Gaseous hydrocarbonaceous fuels may also be burned in the partial oxidation gasifier alone or along with liquid hydrocarbonaceous fuel.

The partial oxidation reaction is preferably carried out in a free-flow, unpacked non-catalytic gas generator. Under high temperature and high pressure conditions, about 98% to 99.9% of the hydrocarbonaceous feedstock can be converted to a synthesis gas containing carbon monoxide and hydrogen, also referred to as synthesis gas or syngas. Carbon dioxide and water are also formed in small amounts.

Water is further used as quench water to quench the syngas. This quench water is also used to scrub particulate matter from the syngas and to cool and/or convey particulate waste solids, such as ash and/or slag out of the gasifier. In order to conserve water, gasification units reuse most of the quench water. A portion of the water is normally continuously removed as an aqueous effluent, grey water, purge wastewater or blowdown stream to prevent excessive buildup of solid materials and undesired dissolved solids.

The composition of the grey water discharged from the gasification system is fairly complex. This water can contain chlorides, ammonium salts, and other potentially environmentally harmful dissolved materials such as sulfide and cyanide. Thus, the effluent wastewater from the gasification system cannot be discharged to the environment without treatment and solids removal.

The grey water blowdown stream is discharged from the gasification system, and is treated with chemicals to precipitate impurities in the grey water. For example, Ferrous Sulfate (FeSO₄) can be added to produce an iron hydroxide floc (Fe(OH)₂) to remove any sulfide, cyanide and particulate matter. This process is usually done in a combination rapid mix reactor and solids settler. The chemicals are added to the rapid mix reactor where they are mixed with the grey water. The effluent from the rapid mix reactor is sent to the solids settler, where any precipitated solids and particulate matter are allowed to settle out of the grey water. After having the solids removed, the grey water can be subjected to ammonia stripping, biological treatment, or evaporation to produce a dry salt for commercial marketing and a distillate water. The water can then be recycled to the gasification quench process thereby eliminating any wastewater discharge from the plant.

Referring first to FIG. 1, a common prior art solids settler is shown. Solids-containing water enters the coagulation chamber 26 of solids settler 30 through line 24. The coagulation chamber 26 is defined by a circular wall 28 in solids settler 30. In coagulation chamber 26 the solids and precipitates in the water are allowed to fall out of solution. The solids fall to the conical shaped bottom 32 of the solids settler 30, where they are removed via line 34 and are sent to a filter press (not shown).

Generally solid-free water, otherwise known as clarified water, leaves out the top of the solids settler 30 through line 36. After leaving the settler, the clarified water is sent to a downstream processing unit for further treatment, usually an alkalization reactor (not shown).

It was observed that in prior art coagulation chambers that the inlet flow pattern behaved as in invert cone. Looking at FIG. 4, the prior art inlet 24 to the coagulation chamber 26 enters in the middle of the coagulation chamber 26, and invert cone 25 is formed by the entering grey water. Very little mixing occurs in the dead zone 27 around the invert cone. It would thus be desirable to develop a solids settler in which the entire space within the coagulation chamber can be used for mixing and solids coagulation/floc production.

### SUMMARY OF THE INVENTION

The present invention involves a new design for a solids settler for use in solids removal from a liquid. The new solids settler design includes a liquid inlet means that injects the feed to the solids settler into an inner coagulation chamber of the solids settler. The liquid inlet means directs the flow of the feed so that the feed flows in a circular pattern within the coagulation chamber. The coagulation chamber also has a partially closed bottom portion that causes the feed to reflex, providing for additional mixing within the coagulation chamber

### BRIEF DESCRIPTION OF THE DRAWINGS

FIG. 1 illustrates a common prior art solids settler.

FIG. 2 shows an improved solids settler.

FIG. 3 illustrates the inlet flow path of the improved solids settler of the present invention.

FIG. 4 shows the inlet flow path of a prior art solids settler.

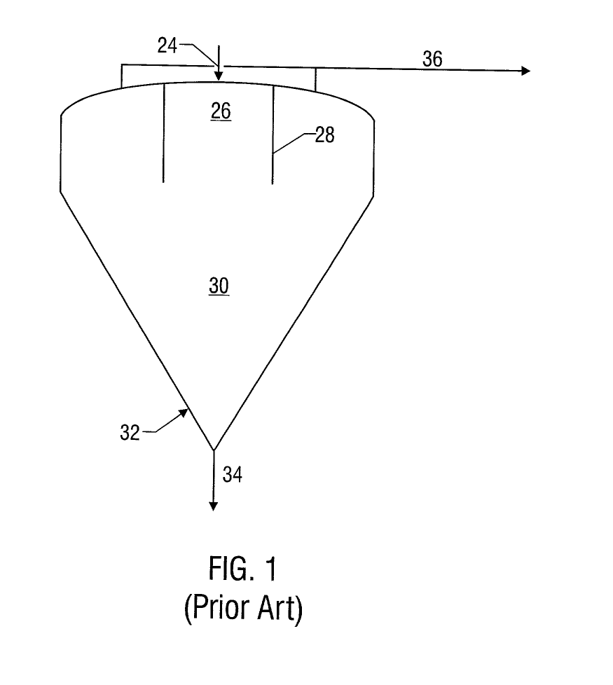

### DESCRIPTION OF ILLUSTRATIVE EMBODIMENTS

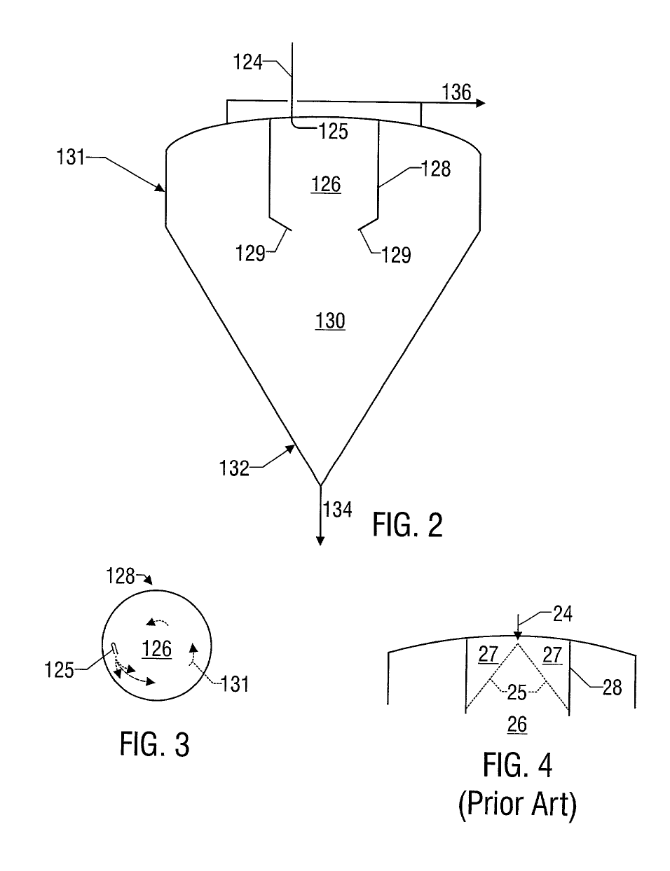

The inventive solids settler involves a new design for the solids settler. The proposed design is simple and effective for solids settling. Referring to FIG. 2, the improved solids settler 130 is shown, the settler 130 having an outer enclosure that preferably takes the form of an upper cylindrical portion 131 and a lower conical portion 132. A solid-containing liquid, such as treated grey water, flows through line 124 and enters through nozzle 125 into coagulation chamber 126. The inlet 125 is tangential to the radius of the coagulation chamber 126. The inlet 125 is preferably placed adjacent to the upper end of the coagulation chamber 126, and because it has a tangential orientation it does not face the center of the chamber. This creates a circular flow pattern in the coagulation chamber 126, utilizing all the space in the coagulation chamber 126. Referring to FIG. 3, the tangential inlet 125 in coagulation chamber 126 creates circular flow pattern 131. Preferably, inlet nozzle 125 is located adjacent to the outer wall 128 of the coagulation chamber 126.

The drawing shows a single inlet, but it should be understood that multiple inlets into the coagulation chamber 126 can be used, so long as the multiple inlets make a circular flow inside the coagulation chamber 126 as is shown in FIG. 3. For example, an inlet with a distribution manifold located either inside or outside of the settler has several inlet tips. Other multiple inlet means known in the art that provide multiple inlet tips can also be used.

Returning now to FIG. 2, coagulation chamber 126 is preferably defined by a circular wall 128 located within the upper cylindrical portion of solids settler 130. The coagulation chamber 126 of the present invention is also equipped with a partially closed slop bottom 129 at the lower end of the coagulation chamber 126. The partially closed slop bottom 129 preferably comprises a downwardly sloping wall, with the preferred slope of the wall being at an angle of about 15 degrees below horizontal. The combination of the circular flow and the partially closed slop bottom 129 causes the circular flow to reflex, causing some mixing in the coagulation chamber 126. This has the effect of a slow mix reactor, which promotes the growth of floc generated by the rapid mix reactor 114. In some prior art installations, a slow mix reactor is placed between an upstream rapid mix reactor and the solids settler. The present invention eliminates any need for this unit from prior art applications.

In coagulation chamber 126 the sludge, comprising solids and precipitates in the water, are allowed to precipitate and fall out of solution. Because of the circular flow and the use of the partially closed slop bottom 129, the coagulated floc grows bigger and settles quicker, improving the clarity of the clarified water. The solids fall to the lower conical portion 132 of the solids settler 130, where they are removed via sludge outlet line 134, preferably located in the lowermost portion of the solids settler 130, and are pumped to filters or a filter press (not shown). A portion of the sludge/floc removed via line 134 may also be returned to the feed of the solids settler if desired to promote additional floc formation if such additional floc formation is necessary or desired. Generally solid-free water, otherwise known as clarified water, leaves out the top of the solids settler 130 through line 136 through a plurality of liquid outlet means located radially between the coagulation chamber and the outer enclosure of the solids settler 130.

It was observed that in prior art coagulation chambers that the inlet flow pattern behaved as in invert cone. Looking at FIG. 4, the prior art inlet 24 to the coagulation chamber 26 enters in the middle of the coagulation chamber 26, and invert cone 25 is formed by the entering grey water. Very little mixing occurs in the dead zone 27 around the invert cone. By making the single or multiple inlets tangential to the radius of the coagulation chamber, as is done in the present invention, all of the space in the coagulation chamber 126 is used for mixing.

One of ordinary skill in the art should recognize that the present invention encompasses an apparatus comprising an outer enclosure, a coagulation chamber having an upper end and a lower end, the coagulation chamber being located within the outer enclosure, a sludge outlet means located on the outer enclosure, a plurality of liquid outlet means, the plurality of liquid outlet means located radially between the coagulation chamber and the outer wall; and a plurality of inlet means located within the coagulation chamber, the plurality of inlet means being capable of directing a flow through the plurality of inlet means in a tangential direction to the radius of the coagulation chamber.

The outer enclosure may comprise an upper cylindrical portion and a lower conical portion, wherein the sludge outlet means is located at the lowermost portion of the lower conical portion of the outer wall and the coagulation chamber is positioned concentrically with the upper cylindrical portion of the apparatus. Preferably the open lower end of the coagulation chamber is partially closed, most preferably by a downwardly sloping wall, the angle of the downward slope preferably being about 15 degrees below horizontal. Finally, the flow direction means is preferably adjacent to the upper end of the coagulation chamber.

The present invention further encompasses a method comprising feeding a solids-containing liquid feed into a coagulation chamber of a settler in such a manner so that the flow into the coagulation chamber is tangential to the radius of the coagulation chamber; allowing the solids to separate from the liquid feed; removing the solids from the settler; and removing the liquid from the settler. The method may further comprise reflexing the solids-containing liquid feed in the coagulation chamber, with the reflexing action being caused by a partially closed slop bottom in the coagulation chamber. Preferably the partially closed slop bottom comprises a downwardly sloping wall, the angle of the downwardly sloping wall being about 15 degrees below horizontal.

While the apparatus and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention. In particular, it should be noted that although the preferred embodiments were described as a treatment for grey water from a gasification process, the apparatus and methods of this invention can be used for any type of solids removal system that uses an integrated rapid mix reactor/solids settler system or variation thereof.

What is claimed is:

1. An apparatus comprising:
an outer enclosure;
a coagulation chamber having an upper end and an open lower end, the coagulation chamber being located within the outer enclosure;
a sludge outlet means located on the outer enclosure;
a plurality of liquid outlet means, the plurality of liquid outlet means located radially between the coagulation chamber and the outer wall; and
a plurality of inlet means located within the coagulation chamber, the plurality of inlet means being capable of directing a flow through the plurality of inlet means in a tangential direction to the radius of the coagulation chamber.

2. The apparatus of claim 1 wherein the outer enclosure comprises an upper cylindrical portion and a lower conical portion.

3. The apparatus of claim 2, wherein the sludge outlet means is located at the lowermost portion of the lower conical portion of the outer wall.

4. The apparatus of claim 2, wherein the coagulation chamber is positioned concentrically with the upper cylindrical portion of the apparatus.

5. The apparatus of claim 1 wherein the open lower end of the coagulation chamber is partially closed.

6. The apparatus of claim 5 wherein the coagulation chamber is partially closed by a downwardly sloping wall.

7. The apparatus of claim 6 wherein the downwardly sloping wall slopes at an angle of about 15 degrees below horizontal.

8. The apparatus of claim 1 wherein the flow direction means is adjacent to the upper end of the coagulation chamber.

9. A method comprising:
feeding a solids-containing liquid feed into a coagulation chamber of a settler in such a manner so that the flow into the coagulation chamber is tangential to the radius of the coagulation chamber;
allowing the solids to separate from the liquid feed;
removing the solids from the settler; and
removing the liquid from the settler.

10. The method of claim 9 further comprising reflexing the solids-containing liquid feed in the coagulation chamber.

11. The method of claim 10 wherein the reflexing action is caused by a partially closed slop bottom in the coagulation chamber.

12. The method of claim 11 wherein the partially closed slop bottom comprises a downwardly sloping wall.

13. The method of claim 12 wherein the downwardly sloping wall slopes at an angle of about 15 degrees below horizontal.
